(19) United States
(12) Patent Application Publication
(10) Pub. No.: US 2007/0146799 A1
(43) Pub. Date: Jun. 28, 2007

(54) Method of thumbnail scanback photo selection

(75) Inventor: John Thomas Writt, Lexington, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(73) Assignee: Lexmark International, Inc.

(21) Appl. No.: 11/319,354

(22) Filed: Dec. 28, 2005

(51) Int. Cl. G06F 3/12

(52) U.S. Cl. 358/302; 358/1.15

(57) ABSTRACT

A method for selecting an image to be processed from an index sheet having a plurality of thumbnail images includes forming a perforation border around each thumbnail image of the plurality of thumbnail images; making a selection of desired thumbnail images from the plurality of thumbnail images by separating a portion of the plurality of thumbnail images from the index sheet; and scanning the index sheet having the portion separated therefrom to determine the selection.

### BACKGROUND OF THE INVENTION

1. Field of the Invention.

The present invention relates to printing with an imaging apparatus, and more particularly, to a method for selecting an image to be processed from an index sheet having a plurality of thumbnail images.

2. Description of the Related Art.

A typical imaging apparatus, such as a printer or an All-In-One machine (AIO), includes a print engine for forming an image on one or more sheets of print media, such as paper, using ink and/or toner. Such a print engine may be, for example, an ink jet print engine having a reciprocating printhead carrier, or an electrophotographic (e.g., laser) print engine. An AIO, also sometimes referred to as a multifunction device (MFD), is configured to perform stand alone functions, and in addition to a print engine, typically includes a scanner for performing copying or facsimile transmission. The AIO may be connected to a host computer via a communications link to facilitate a printing function.

Such imaging apparatus may be used for normal printing or photo printing. In photo printing, a thumbnail print of each of the available images may be generated on an index sheet so that the user can select certain images corresponding to the thumbnail print for printing. For example, one popular method to select which photos to print from images stored in a digital camera and/or memory card is to print a thumbnail index sheet; mark the selections on the thumbnail index sheet, or a separate bubble sheet, such as by filling in corresponding bubbles; and scanning the marked thumbnail index sheet or bubble sheet to read in the user's selections. After the desired photos are printed, the thumbnail index sheet is often thrown away, which the user may perceive as somewhat wasteful of ink and media.

### SUMMARY OF THE INVENTION

The invention, in one exemplary embodiment, is directed to a method for selecting an image to be processed from an index sheet having a plurality of thumbnail images. The method includes forming a perforation border around each thumbnail image of the plurality of thumbnail images; making a selection of desired thumbnail images from the plurality of thumbnail images by separating a portion of the plurality of thumbnail images from the index sheet; and scanning the index sheet having the portion separated therefrom to determine the selection.

The invention, in another exemplary embodiment, is directed to a method for selecting an image to be processed from an index sheet having a plurality of thumbnail images. The method includes forming a perforation border around each thumbnail image of the plurality of thumbnail images; making a selection of desired thumbnail images from the plurality of thumbnail images by separating a portion of the plurality of thumbnail images from the index sheet; scanning the index sheet having the portion separated therefrom to determine the selection; and printing a normal image corresponding to each of the desired thumbnail images selected based on the scanned determination of the selection.

The invention, in another exemplary embodiment, is directed to a method for selecting an image to be processed from an index sheet having a plurality of thumbnail images. The method includes forming a perforation border around each thumbnail image of the plurality of thumbnail images; making a selection of desired thumbnail images from the plurality of thumbnail images by separating a portion of the plurality of thumbnail images from the index sheet; scanning the separated portion of the plurality of thumbnail images to determine the selection; and printing a normal image corresponding to each of the desired thumbnail images selected based on the scanned determination of the selection.

The invention, in another exemplary embodiment, is directed to a method for selecting an image to be processed from an index sheet having a plurality of thumbnail images viewable from a face side of the index sheet. The method includes forming a perforation border around each thumbnail image of the plurality of thumbnail images; making a selection of desired thumbnail images from the plurality of thumbnail images by folding back a portion of the plurality of thumbnail images from the index sheet; and scanning the index sheet having the portion folded back to determine the selection.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 is a diagrammatic representation of a system embodying the present invention.

FIG. 2 is an exemplary index sheet having a plurality of thumbnail images printed thereon.

FIG. 3 is a general flowchart of a method for selecting an image to be processed from an index sheet having a plurality of thumbnail images, in accordance with an embodiment of the present invention.

FIG. 4 illustrates the index sheet of FIG. 3, with a portion of the thumbnail images removed.

Corresponding reference characters indicate corresponding parts throughout the several views. The exemplifications set out herein illustrate one or more embodiments of the invention, and such exemplifications are not to be construed as limiting the scope of the invention in any manner.

### DETAILED DESCRIPTION OF THE INVENTION

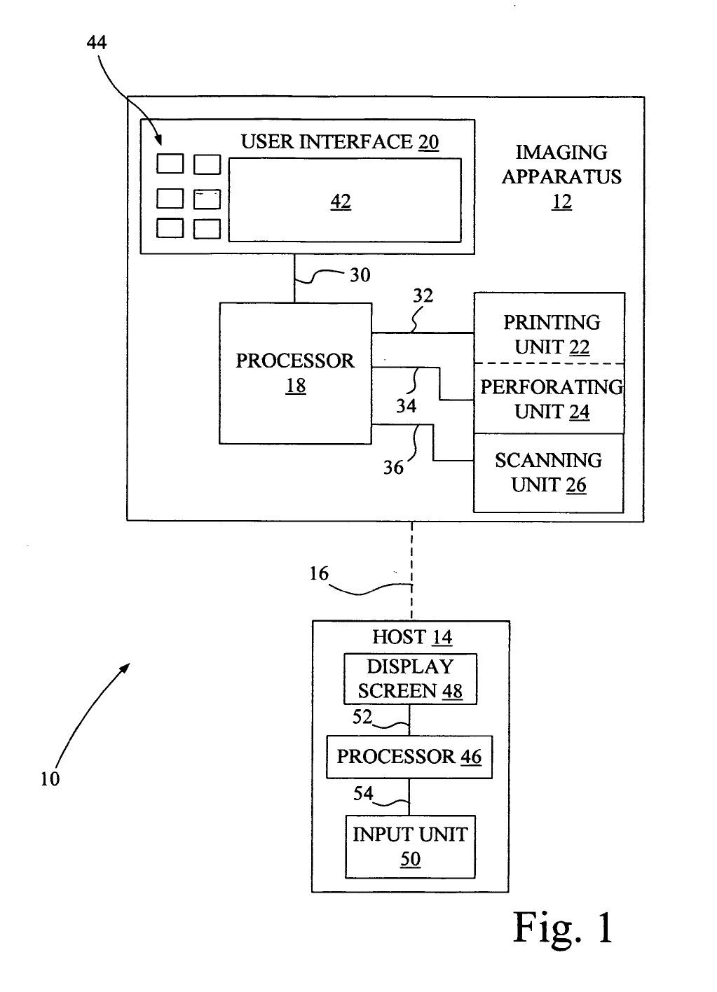

Referring now to the drawings and particularly to FIG. 1, there is shown an imaging system 10 embodying the present invention. Imaging system 10 includes an imaging apparatus 12, and optionally, a host 14.

Imaging apparatus 12 may be, for example, a combined printer/perforating apparatus, and may take the form of an All-In-One Machine (AIO), such as for example, a standalone unit that has perforating, scanning, copying, and/or faxing functionality, in addition to printing functionality. Host 14, which may be optional, may be communicatively coupled to imaging apparatus 12 via a communications link 16. Communications link 16 is depicted as a dashed line to represent the optional coupling of imaging apparatus 12 to host 14.

As used herein, the term “communications link” generally refers to structure that facilitates electronic communication between two components, and may operate using wired or wireless technology. Accordingly, communications link 16 may be, for example, a direct electrical wired connection, a direct wireless connection (e.g., infrared or r.f.), or a network connection (wired or wireless), such as for example, an Ethernet local area network (LAN) or a wireless networking standard, such as IEEE 802.11.

Imaging apparatus 12 includes a processor 18, a user interface 20, a printing unit 22, a perforating unit 24, and a scanning unit 26. With the present invention, it may be advantageous in some embodiments for perforating unit 24 to be combined with printing unit 22 in a single imaging apparatus, as shown in FIG. 1. However, those skilled in the art will recognize that the principles of the present invention may be achieved in systems where perforating unit 24 is independent from printing unit 22.

Processor 18 of imaging apparatus 12 may be, for example, an application specific integrated circuit (ASIC) having processing capabilities, and may include a microprocessor and associated memory. Processor 18 is communicatively coupled to user interface 20 via a communications link 30. Processor 18 is communicatively coupled to printing unit 22 via a communications link 32. Processor 18 is communicatively coupled to perforating unit 24 via a communications link 34. Processor 18 is communicatively coupled to scanning unit 26 via a communications link 36.

Processor 18 executes program instructions, in firmware or software, to provide operational control of printing unit 22 and a perforating unit 24. In some embodiments of imaging apparatus 12, such as for example where imaging apparatus 12 is an AIO, processor 18 may include in its memory a software or firmware program including program instructions that function as a driver for printing unit 22 and/or perforating unit 24, and will be referred to herein as a driver program. The driver program, for example, may include a halftoning unit and a data formatter subroutine that places print data and print commands in a format that can be recognized by printing unit 22, and may include a perforating driver subroutine for identifying perforation boundaries, and for placing perforation data in a format that can be recognized by perforating unit 24.

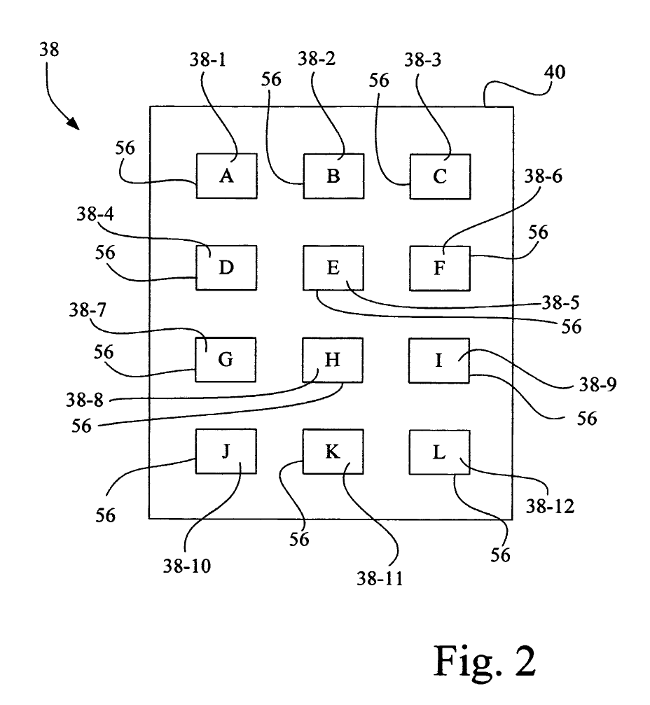

In addition, processor 18 executes program instructions to process job data for use by at least one of printing unit 22 and perforating unit 24. The job data may include, for example, printing data, and perforating data generated as a result of executing program instructions to perform perforation in accordance with the present invention around one or more of a plurality of thumbnail images 38 printed on an index sheet 40, as illustrated for example in FIG. 2. In FIG. 2, individual thumbnail images of the plurality of thumbnail images 38 are identified as 38-1, 38-2, 38-3, 38-4, 38-5, 38-6, 38-7, 38-8, 38-9, 38-10, 38-11, and 38-12. Each of the thumbnail images 38 represent a normal image stored in memory, such as memory accessible by imaging apparatus 12 or host 14. The job data may be generated locally, as when imaging apparatus 12 is operating in a standalone mode. Alternatively, the job data may be generated remotely by host 14.

User interface 20 includes a display screen 42 and a plurality of input devices 44. Display screen 42 may be, for example, a liquid crystal display (LCD). Display screen 42 may display, for example, a preview of the perforating operation to be performed. The plurality of input devices 44 may include, for example, a plurality of buttons, and a pointer device, such as a joystick or trackball. Each of the plurality of input devices 44 is communicatively coupled to processor 18 via communications link 30. Processor 18 executes program instructions to receive a status of each of the plurality of input devices 44.

Printing unit 22 may be, for example, an ink jet print engine, or other suitable print engine for forming an image on a sheet of media, such as index sheet 40, or other paper. The print engine may be, for example, an ink jet print engine having a reciprocating printhead carrier for transporting one or more ink jet printheads for performing a printing operation, the operation of which is well known in the art.

Perforating unit 24 may include, for example, a perforation device for forming perforations, i.e., holes, at a predetermined spacing, i.e., perforation density, in the sheet of media. One example of a perforation device, which may also be used for cutting, includes a reciprocating needle assembly that may be attached to the printhead carrier of the printing unit 22.

Scanning unit 26 may include, for example, a scan bed for receiving a document to be scanned. For example, during a scanning operation the media, e.g., index sheet 40, to be scanned may be placed on the document glass of the scan bed, and a scan bar may be moved in relation to the media to form a scanned image.

In embodiments including host 14, host 14 may be, for example, a personal computer including a processor 46, a display screen 48 (e.g., a monitor device) and an input unit (e.g., keyboard) 50, and associated input/output (I/O) interfaces. Processor 46 may include, for example, a microprocessor and associated memory, such as RAM, ROM, NVRAM, and a mass data storage device, such as a hard drive, CD-ROM and/or DVD units.

Processor 46 is communicatively coupled to display screen 48 via communications link 52. Processor 46 is communicatively coupled to input unit 50 via communications link 54. Further, processor 46 is communicatively coupled to processor 18 of imaging apparatus 12 via communication link 16.

In embodiments that include host 14, host 14 may include in its memory all, or a portion, of the driver program including program instructions that function as a driver for imaging apparatus 12. The driver program, for example, may include a halftoning unit and a data formatter subroutine that places print data and print commands in a format that can be recognized by printing unit 22, and may include a perforating driver subroutine for identifying perforation boundaries, and for placing perforation instructions or data in a format that can be recognized by perforating unit 24. In addition, processor 18 executes program instructions to process job data for use by at least one of printing unit 22 and perforating unit 24. The driver program may be accessed, for example, by a software application, such as for example, a word processing application, a photo generation application, a perforation application, etc., that is executing on host 14.

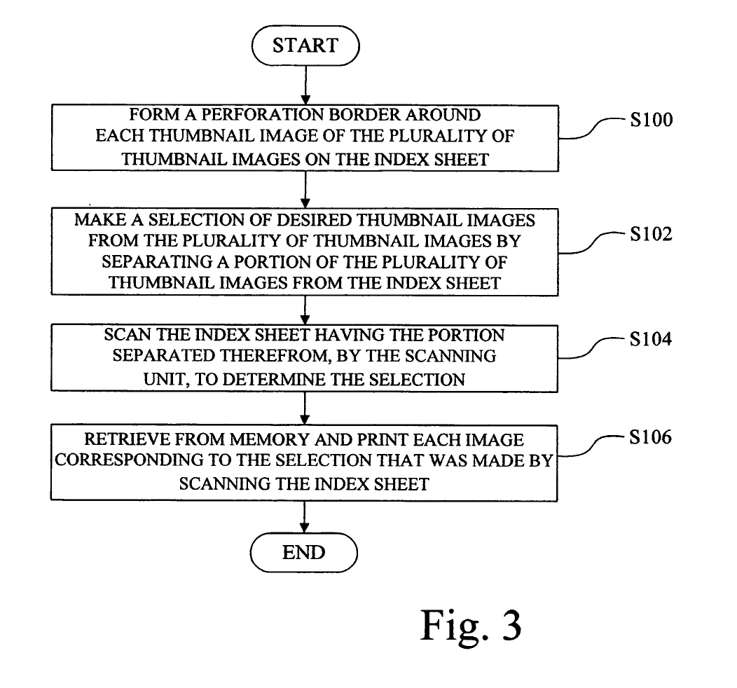

FIG. 3 is a general flowchart of a method in accordance with an embodiment of the present invention for selecting an image to be processed from an index sheet, such as index sheet 40, having a plurality of thumbnail images, such as thumbnail images 38, as illustrated in FIG. 2, printed on and viewed from a face side of index sheet 40. Where applicable, the process steps described below may be performed, for example, by program instructions executed by a processor, such as processor 18 of imaging apparatus 12 or processor 46 of host 14.

At step S100, a perforation border 56 is formed around each thumbnail image of the plurality of thumbnail images 38 on index sheet 40. Perforation border 56 is formed, for example, by forming perforations around the image perimeter of each thumbnail image of the plurality of thumbnail images 38 using perforating unit 24.

In embodiments where imaging apparatus 12 prints index sheet 40, for example, the location of perforation border 56 around each thumbnail image of the plurality of thumbnail images 38 on index sheet 40 may be determined by determining an outer edge of each thumbnail image by analyzing the thumbnail image data, for example, by processor 18, and forming perforation border 56 along the edge of each thumbnail image. As an alternative, the edges around each thumbnail image of the plurality of thumbnail images 38 may be determined by scanning index sheet 40 with scanning unit 26, and then analyzing the scan data to determine the location of the edges around each thumbnail image of the plurality of thumbnail images 38.

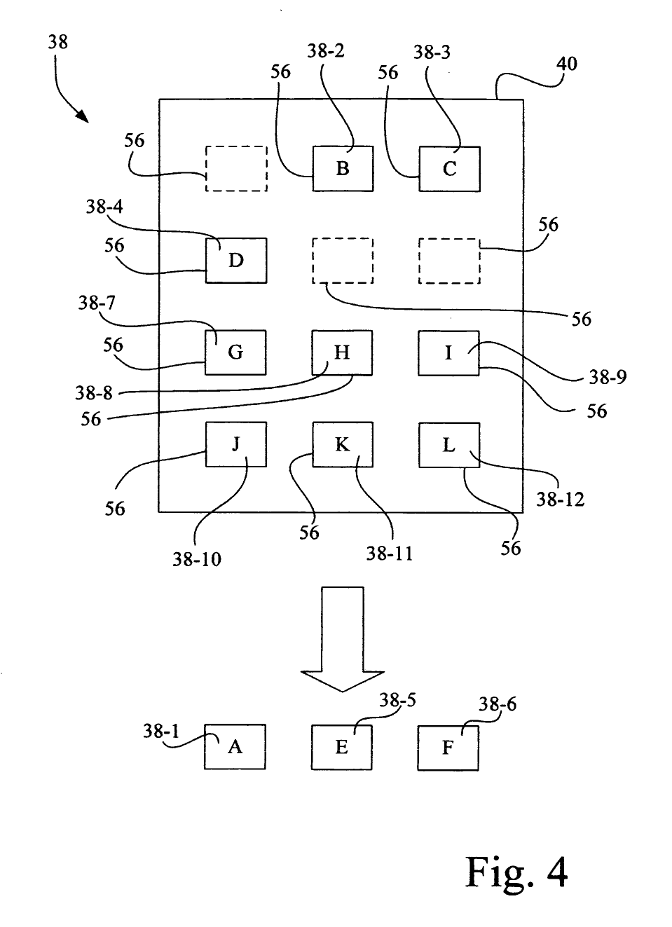

At step S102, a selection of desired thumbnail images from the plurality of thumbnail images 38 is made by separating a portion of the plurality of thumbnail images 38 from the index sheet 40. As illustrated in FIG. 4, for example, a user may select thumbnail images 38-1, 38-5 and 38-6 as the portion to be separated from index sheet 40. The portion, however, may include all of thumbnail images 38, if desired.

In one embodiment, for example, the selection may determine each image to be printed based on the thumbnail images removed from index sheet 40. In other words, referring to the example of FIG. 4, normal images corresponding to thumbnail images 38-1, 38-5 and 38-6 would be selected for printing.

Alternatively, in another embodiment, for example, the selection may determine each image to be printed based on the thumbnail images remaining on index sheet 40. In other words, referring to the example of FIG. 4, normal images corresponding to thumbnail images 38-2, 38-3, 38-4, 38-7 . . . 38-12 would be selected for printing.

At step S104, index sheet 40, having the portion separated therefrom, is scanned by scanning unit 26 to determine the selection by imaging apparatus 12. For example, imaging apparatus 12 already knows which thumbnail image was printed in each location on index sheet 40, since imaging apparatus 12 either printed index sheet 40 or pre-scanned index sheet 40. Thus, upon scanning index sheet 40 having a portion of the thumbnail images 38 removed, imaging apparatus 12 makes note of which thumbnail images are no longer present.

Orientation markings may be printed on the thumbnail sheet, either for the user during scanner placement or for imaging apparatus 12 to automatically rotate and align the scanned image of index sheet 40 as needed in order to accurately determine the selection.

At step S106, each image corresponding to the selection, as determined by scanning index sheet 40, is retrieved from memory and printed by printing unit 22. Thus, based on the determination made at step S104, in one embodiment, the actual images corresponding to the thumbnail images removed from index sheet 40 may be printed by printing unit 22. In another embodiment, the actual images corresponding to the thumbnail images remaining on index sheet 40 may be printed by printing unit 22.

As an alternative to step S102, the selection of desired thumbnail images from the plurality of thumbnail images 38 may be made by folding back a portion of the plurality of thumbnail images 38 of index sheet 40. For example, perforation border 56 may be formed on each of the four sides, e.g., edges, around the thumbnail image, or alternatively, perforation border 56 may be formed on any three of the four sides, e.g., edges, of the thumbnail image. Accordingly, the thumbnail image to be folded back may be separated from index sheet 40 along three sides, e.g., edges, of the thumbnail image, and folded back along the fourth side, so that the thumbnail image faces away from the face side of index sheet 40.

Also, as an alternative to the method described above, step 104 may be modified, such that rather than scanning index sheet 104, the separated thumbnail images that are removed from index sheet 40 are scanned by scanning unit 26, and then imaging apparatus 12 or host 14, running image recognition software, determines the selection based on the scanned image of the separated thumbnail images.

One advantage of the present invention is the ability to easily use the thumbnail images 38 as pictures themselves after scanning, since they can be easily punched out from index sheet 40.

While this invention has been described with respect to exemplary embodiments, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A method for selecting an image to be processed from an index sheet having a plurality of thumbnail images, comprising:
forming a perforation border around each thumbnail image of said plurality of thumbnail images;
making a selection of desired thumbnail images from said plurality of thumbnail images by separating a portion of said plurality of thumbnail images from said index sheet; and
scanning said index sheet having said portion separated therefrom to determine said selection.

2. The method of claim 1, wherein said selection is based on the thumbnail images removed from said index sheet.

3. The method of claim 1, wherein said selection is based on the thumbnail images remaining on said index sheet.

4. The method of claim 1, wherein said perforation border is formed at an edge of each thumbnail image.

5. A method for selecting an image to be processed from an index sheet having a plurality of thumbnail images, comprising:
forming a perforation border around each thumbnail image of said plurality of thumbnail images;
making a selection of desired thumbnail images from said plurality of thumbnail images by separating a portion of said plurality of thumbnail images from said index sheet;
scanning said index sheet having said portion separated therefrom to determine said selection; and
printing a normal image corresponding to each of said desired thumbnail images selected based on the scanned determination of said selection.

6. The method of claim 5, wherein said selection is based on the thumbnail images removed from said index sheet.

7. The method of claim 5, wherein said selection is based on the thumbnail images remaining on said index sheet.

8. The method of claim 5, wherein said perforation border is formed at an edge of each thumbnail image.

9. A method for selecting an image to be processed from an index sheet having a plurality of thumbnail images, comprising:
forming a perforation border around each thumbnail image of said plurality of thumbnail images;
making a selection of desired thumbnail images from said plurality of thumbnail images by separating a portion of said plurality of thumbnail images from said index sheet;
scanning the separated portion of said plurality of thumbnail images to determine said selection; and
printing a normal image corresponding to each of said desired thumbnail images selected based on the scanned determination of said selection.

10. The method of claim 9, wherein said perforation border is formed at an edge of each thumbnail image.

11. A method for selecting an image to be processed from an index sheet having a plurality of thumbnail images viewable from a face side of said index sheet, comprising:
forming a perforation border around each thumbnail image of said plurality of thumbnail images;
making a selection of desired thumbnail images from said plurality of thumbnail images by folding back a portion of said plurality of thumbnail images from said index sheet; and
scanning said index sheet having said portion folded back to determine said selection.

12. The method of claim 11, wherein said perforation border is formed at an edge of each thumbnail image.

13. The method of claim 11, wherein said perforation border is formed along at least three sides of each thumbnail image.

14. The method of claim 11, wherein said scanning is performed by scanning said face side of said index sheet.

15. The method of claim 11, wherein said scanning is performed by scanning a side of said index sheet opposite to said face side.
